(19) United States
(12) Patent Application Publication
(10) Pub. No.: US 2002/0033811 A1
(43) Pub. Date: Mar. 21, 2002

(54) Drive circuit for vacuum fluorescent display tube

(75) Inventor: Kousuke Kinoshita, Shizuoka (JP)

Correspondence Address: ARMSTRONG,WESTERMAN & HATTORI, LLP, 1725 K STREET, NW., SUITE 1000, WASHINGTON, DC, 20006, US

(73) Assignee: YAZAKI CORPORATION, Tokyo (JP)

(21) Appl. No.: 09/946,688

(22) Filed: Sep. 6, 2001

(30) Foreign Application Priority Data
Sep. 6, 2000 (JP) 2000-270025
Aug. 23, 2001 (JP) 2001-253348

(51) Int. Cl. G09G 5/00

(52) U.S. Cl. 345/204

(57) ABSTRACT

Objects of this Invention The object is to provide a drive circuit for vacuum fluorescent display tubes which can display high resolution images with high quality and high quality dynamic images in VFDs.

How to be Solved

A drive circuit for vacuum fluorescent display tubes, which supplies drive voltages to each corresponded anode and control electrode of plurality of VFDs and displays an image by emitted light of the VFDs, comprises a timing controller 1a for reading out dynamic image data of multiple bits form at each frame timing from a RAM 1c and transferring the dynamic image data in parallel at a unit of multiple bits, a high withstand voltage anode driver 2A₂ for generating drive voltage, based on the transferred dynamic image data, to be supplied on each anode of each VFD and a high withstand voltage anode driver 2A₂ for generating drive voltage, based on the transferred dynamic image data, to be supplied on each control electrode of each VFD.

### BACKGROUND OF THE INVENTION

1. Field of the Invention

This invention relates to a drive circuit for vacuum fluorescent display tubes, for driving VFDs (vacuum fluorescent display tubes) to display dynamic images.

2. Description of the Related Art

There is already such a drive circuit for vacuum fluorescent display tubes to drive VFDs to display an image on a VFD panel by prior art like one example, described in J.P.A. Laid-open No. H7-261694. FIG. 3 shows an outline block diagram of a drive circuit for vacuum fluorescent display tubes by prior art. The circuit by prior art comprises a controller IC1 for serially transferring display data under microprocessor control and a driver IC2 including a first shift resistor portion 2a for inputting the serially transferred display data, and a drive array 2b which comprising a latch resistor (not shown) for latching output data of the first shift resistor portion 2a and supplying the data to vacuum fluorescent display tube segments arranged on the VFD panel, a latch pulse generator portion (not shown) for generating a latch pulse for the latch resistor and a second shift resistor for outputting a voltage shifted one by one to vacuum fluorescent display tube grids at timing of the latch pulse generator output.

According to this prior art, the first shift resistor 2a converts display data, serially transferred from the controller IC1, from serial data to parallel data and outputs image signals for driving vacuum fluorescent display tube segments. The latch pulse, generated by the latch pulse generator portion, is used for latching the latch resistor and also used as shift pulse for the second shift resistor to support generating grid voltages for the vacuum fluorescent display tubes.

A dot matrix VFD is widely used for a display device to display characters or figures in very low resolution. A driver IC by prior art comprises a high withstand voltage driver array portion and a not-so-high withstand voltage shift resistor portion in the same IC circuit packaging and has good enough performance to display characters or figures in very low resolution and also has easy handling structure for users.

Although the controller IC of the driver circuit by prior art has tone function , data transfer rate can be increased hardly to display dynamic images since the image data is transferred serially from the controller IC to the driver IC. Therefore, transferable data volume per second is so small that frame number per second is small and then displayed dynamic images quality is so bad.

This invention has been accomplished to overcome the above drawbacks and an object of this invention is to provide a drive circuit for vacuum fluorescent display tubes that can display high quality images in high resolution and high quality dynamic images.

### SUMMARY OF THE INVENTION

A drive circuit for vacuum fluorescent display tubes, which supplies drive voltage to respective anodes and control electrodes of plurality of vacuum fluorescent display tubes and displays an image by emitted light of the vacuum fluorescent display tubes, comprises a data transfer means for reading out dynamic image data of multiple bits form at each frame timing from a data storage means for storing dynamic image data and transferring the dynamic image data in parallel at a unit of multiple bits, a first drive means for generating drive voltages, based on the transferred dynamic image data, to be supplied on each anode of each vacuum fluorescent display tube and a second drive means for generating drive voltages, based on the transferred dynamic image data, to be supplied on each control electrode of each vacuum fluorescent display tube, wherein each drive voltage, based on the dynamic image data transferred in parallel by the data transfer means, is led simultaneously to each electrode of the vacuum fluorescent display tubes to be activated depending on an image to be displayed.

The data transfer means in the drive circuit for vacuum fluorescent display tubes, according to this invention, sets a tone of displaying image based on a luminance signal level of the dynamic image data and the first drive means changes the drive voltage value to be led to the anode of the vacuum fluorescent display tubes, depending on the tone of the transferred dynamic image data.

The image tone of the image data by the drive circuit for vacuum fluorescent display tubes according to this invention is set by determining a power-on duty ratio of the drive voltage supplied on the anodes based on the luminance signal level.

Effect of Invention

According to this invention, a drive circuit for vacuum fluorescent display tubes, which supplies drive voltage to anodes and control electrodes of plurality of vacuum fluorescent display tubes and displays an image by emitted light of the vacuum fluorescent display tubes, comprises a data transfer means for reading out dynamic image data of multiple bits form at each frame timing from a data storage means for storing dynamic image data and transferring the dynamic image data in parallel at a unit of multiple bits, a first drive means for generating drive voltages, based on the transferred dynamic image data, to be supplied on each anode of the each vacuum fluorescent display tube and a second drive means for generating drive voltages, based on the transferred dynamic image data, to be supplied on each control electrodes of the each vacuum fluorescent display tube, wherein each drive voltage, based on the dynamic image data transferred in parallel by the data transfer means, is led simultaneously to each electrode of the vacuum fluorescent display tubes to be activated depending on an image to be displayed. Therefore, the data transfer rate or transfer data volume is increased and then high quality dynamic images, according with real image, can be displayed.

In the drive circuit for vacuum fluorescent display tubes according to this invention, the data transfer means sets a tone of displaying image based on luminance signal level of the dynamic image data and the first drive means changes the drive voltage value, to be led to the anode of the vacuum fluorescent display tubes depending on the tone of the transferred dynamic image data. Therefore, brightness of each vacuum fluorescent display tube can be adjusted and then high resolution natural images can be displayed.

### BRIEF DESCRIPTION OF THE DRAWINGS

FIG. 1 is a structural block diagram of a drive circuit for vacuum fluorescent display tubes according to this invention;

FIG. 2 is a structural block diagram of a timing controller according to an embodiment of this invention; and

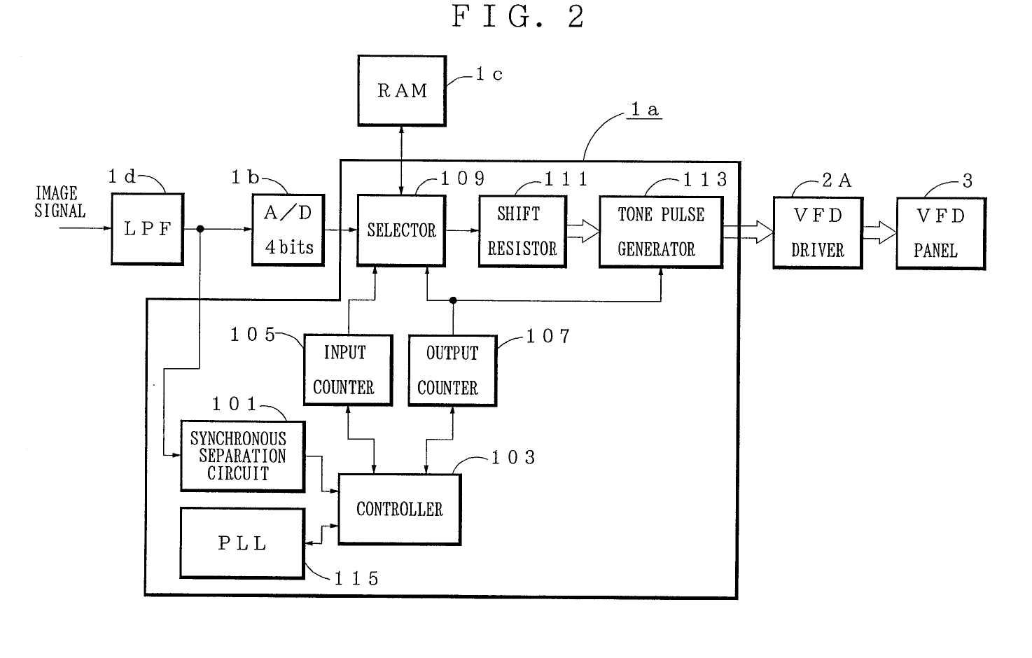

FIG. 3 is a structural block diagram of a drive circuit for vacuum fluorescent display tubes by prior art.

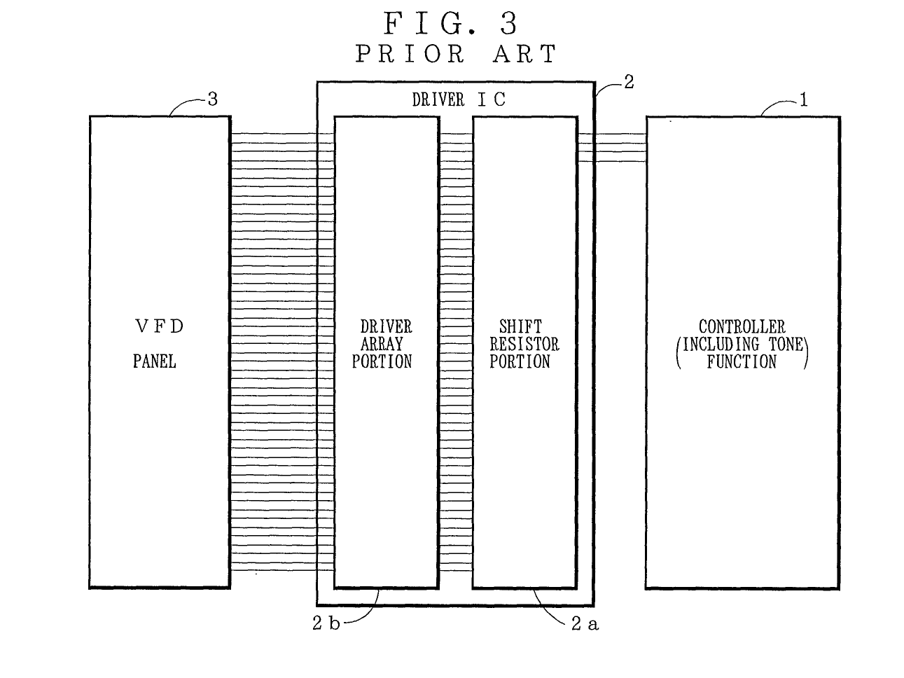

### DESCRIPTION OF THE PREFERRED EMBODIMENT

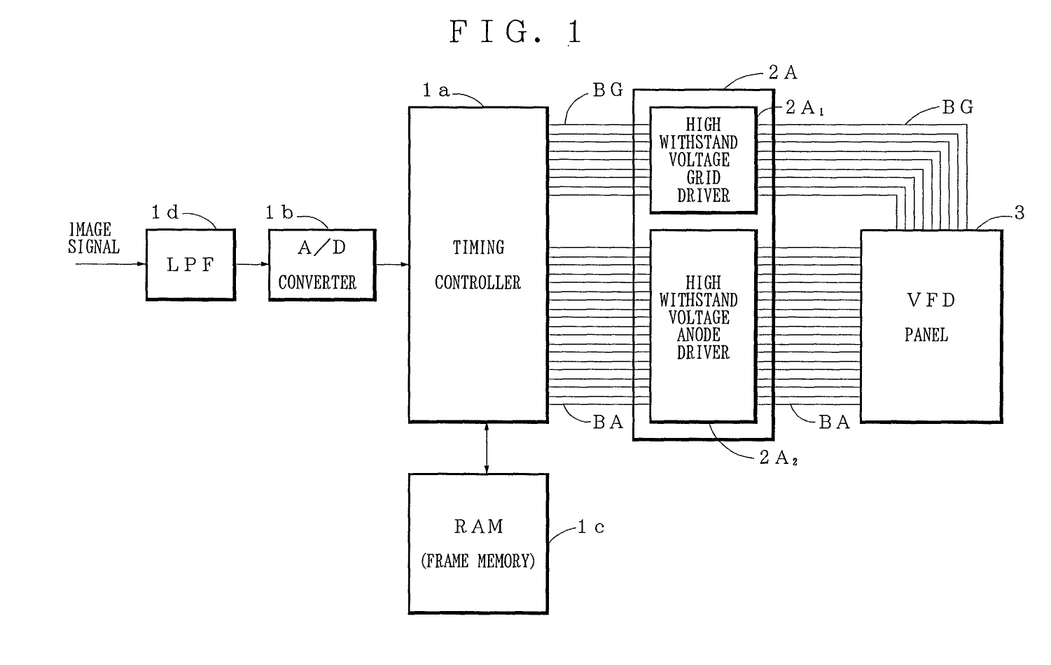

The first embodiment of a drive circuit for vacuum fluorescent display tubes according to this invention will now be described with reference to the attached drawings. FIG. 1 is a block diagram to show structural outline of a drive circuit for vacuum fluorescent display tubes of the embodiment according to this invention. In FIG. 1, 1a is a timing controller and this timing controller 1a receives digital converted image signals by an A/D converter 1b and stores the signals temporally in RAM 1c (frame memory) and after that, reads out display data for VFD panel at horizontal synchronizing signal timing, described later.

After color signal is split from image data by an LPF 1d (low-pass filter), luminance signal part is digital converted by the A/D converter and led to the timing controller 1a.

Display data read from the RAM 1e is transferred to a later-described shift resistor and outputted to bus BG, BA as VFD drive signal (grid drive signal, anode drive signal) from the shift resister.

2A is a high withstand voltage VFD driver array comprising a high withstand voltage grid driver 2A₁ and a high withstand voltage anode driver 2A₂. The high withstand voltage driver array 2A generates grid voltage output and anode voltage output based on VFD drive signals and inputs the output voltage through the bus BG, BA to VFD grids and anodes arranged matrix-like on a VFD panel 3.

The timing controller 1a has tone function and controls voltage impressing time (power-on duty) for VFD anodes based on anode drive signal (luminance signal) level by the high withstand voltage anode driver 2A2. So that it can adjust contrast to change tone of images to be displayed on the VFD panel 3.

Structure of the timing controller 1a will be described next.

The timing controller 1a comprises a synchronous separation circuit 101 which splits synchronous signals from image signals removed color signals by the low-pass filter (LPF) 1d, a controller 103 which outputs sampling dot clocks and output dot clocks individually synchronizing with horizontal synchronizing signals of synchronizing signals, a PLL circuit 115 which synchronizes phase of each clock by the controller 103, an input counter 105 which counts the sampling dot clocks and outputs a recording address of the RAM 1c, an output counter 107 which counts output dot clocks and outputs readout address of the RAM 1c, a selector 109 which selects a recording address outputted by the input counter 105 to store luminance signals of one frame into the RAM 1c or selects a readout address outputted by the output counter 107 to read luminance signals of one frame from the RAM 1c, a shift resistor 111 which parallel outputs luminance signals of one frame read from the RAM 1c through the selector 109 as drive signals for VFD and a tone pulse generator 113 which generates tone pulses to change anode voltage ON duty (tone pulse duty) based on luminance signal level.

The tone pulse generator 113 generates tone pulses of ON duty based on luminance signal level when receiving luminance signals from the shift resistor 111 synchronizing with output dot clocks by the output counter 107. The VFD driver 2A controls anode voltage impressing time (average voltage) with the tone pulse.

Acting of this embodiment will be described as follows.

Firstly, after analogue video signal, inputted by not-shown video camera, is removed color signals by the LPF (low-pass filter) 1d, its signal is led to the A/D converter 1b and converted from analogue luminance signal to 4-bits digital signal and led to the timing controller 1a.

Image signals after removed color signals, outputted by the low-pass filter 1d, are led to the synchronous separation circuit 101 and vertical synchronizing signals and horizontal synchronizing signals are separated from the image signals.

The controller 103 outputs sampling dot clocks and output dot clocks individually synchronizing with the separated horizontal synchronizing signals. The controller 103 synchronizes phase of each output clocks by the PLL circuit 115.

Sampling dot clocks are counted with the counter 105 and the count value is transferred as a recording address to the RAM 1c through a selector. Output dot clocks are counted with output counter 107 and the count value is transferred as readout address to the RAM 1c.

Since scanning direction of image signals and VFD is deferent, the input counter 105 and the output counter 107 are provided to arrange readout address generating order to read recorded image data for VFD against recording address generating order of image signals (luminance signals) in the RAM 1c.

Luminance signals of one frame are recorded as display data synchronizing with horizontal synchronizing signals in the RAM 1c and the display data of one frame are read out with count values by the output counter 107.

The luminance signals of one frame readout through the selector 109 from the RAM 1c are led to the shift resistor 111 and parallel outputted VFD drive signals (grid drive signals, anode drive signals). The anode drive signals are transferred to the tone pulse generator 113 synchronizing with output dot clocks by the output counter 107 and the tone pulse generator generates tone pulses to change the anode voltage ON duty (tone pulse duty) based on luminance signal level. The VFD driver 2A controls anode voltage impressing time (average voltage) with the tone pulse.

The high withstand voltage grid driver 2A₁ and the high withstand voltage anode driver 2A₂ generate plus voltages by each led parallel drive signal and input these plus voltages through bus BA, BG to anodes and grids of VFDs required to emit light. At the time, the high withstand voltage grid driver 2A₂ adjusts anode voltage level with tone pulse ON duty based on luminance signal level.

Thermoelectron, emitted from electric heated filament cathode at approximately 600 degree C for example, is accelerated by pulling up plus voltage on each electrode and radiated to luminophor on anodes and emits light. Acting this operation sequentially for each display data read out from the RAM 1c makes dynamic images on the VFD panel 3.

Since multi-bits display data for drive signals are transferred in parallel from the timing controller 1a to the high withstand voltage driver array 2A simultaneously, as mentioned above, the data transfer rate or transfer data volume is increased and then high quality dynamic images can be displayed. Furthermore, implementing tone function in the timing controller 1a realizes displaying high resolution images with high quality.

The drive circuit for vacuum fluorescent display tubes according to the embodiment of this invention can give high quality display image and then is suitable for HUD (head up display) for a vehicle or a back monitoring system (back monitor).

What is claimed is:

1. A drive circuit for vacuum fluorescent display tubes, which supplies drive voltage to respective anodes and control electrodes of plurality of vacuum fluorescent display tubes and displays an image by emitted light of the vacuum fluorescent display tubes, comprising;
a data transfer means for reading out dynamic image data of multiple bits form at each frame timing from a data storage means for storing dynamic image data and transferring the dynamic image data in parallel at a unit of multiple bits;
a first drive means for generating drive voltages based on the transferred dynamic image data, to be supplied on each anode of each vacuum fluorescent display tube; and
a second drive means for generating drive voltages, based on the transferred dynamic image data, to be supplied on each control electrode of each vacuum fluorescent display tube, wherein each drive voltage, based on the dynamic image data transferred in parallel by the data transfer means, is led simultaneously to each electrode of the vacuum fluorescent display tubes to be activated depending on an image to be displayed.

2. The drive circuit for vacuum fluorescent display tubes according to claim 1, wherein the data transfer means sets a tone of displaying image based on a luminance signal level of the dynamic image data and the first drive means changes the drive voltage value to be led to said anode of the vacuum fluorescent display tubes, depending on the tone of the transferred dynamic image data.

3. The drive circuit for vacuum fluorescent display tubes according to claim 2, wherein said tone of the image data is set by determining a power-on duty ratio of the drive voltage supplied to the anodes based on the luminance signal level.
